(19) United States
(12) Patent Application Publication
(10) Pub. No.: US 2016/0143214 A1
(43) Pub. Date: May 26, 2016

(54) AGRICULTURAL MACHINE WITH A GRANULAR MATERIAL SUPPLY CONTAINER THAT CAN BE REMOVED WITHOUT THE USE OF TOOLS

(71) Applicant: DEERE & COMPANY, MOLINE, IL (US)

(72) Inventors: MARTIN KREMMER, MANNHEIM (DE); CHRISTIAN WAIBEL, MANNHEIM (DE); VALENTIN GRESCH, ENSHEIM (DE)

(21) Appl. No.: 14/946,410

(22) Filed: Nov. 19, 2015

(30) Foreign Application Priority Data
Nov. 26, 2014 (DE) 102014224058.1

(51) Int. Cl. A01C 7/20; A01C 7/08

(52) U.S. Cl. CPC A01C 7/20; A01C 7/08

(57) ABSTRACT

An agricultural machine is equipped with a frame, on which a discharging device for granular material and a supply container for granular material are fastened, which can be supplied to the discharging device. The supply container can be removed and thus connected with the frame and the discharging device without the use of tools.

### FIELD OF USE

This disclosure relates to an agricultural machine with a granular material supply container that can be removed without the use of tools.

### BACKGROUND

Granular material has to be discharged in some agricultural work. Examples of this are to be found in sowing machines, in which seed is taken from a seed container and is discharged into a furrow in the ground, or centrifugal fertilizer spreaders, in which fertilizer particles are taken from a container and spread over the ground. Such supply containers are usually firmly and permanently connected with the machine and can, if necessary, be removed for repair purposes, in which case screws have to be loosened.

In sowing machines, the supply containers for the seed are, as a rule, correlated with individual series units—see EP 2 517 545 A1. If the type of seed is then to be changed while the supply container, however, is partially filled, it is necessary in the state of the art to empty the supply container manually, with a shovel or something similar, which is rather time-consuming in the case of sowing machines with a relatively large number of series units. Also, the supply container has to be detached from the sowing machine if maintenance work has to be carried out on a metering device, in order to be able to have access to the metering device and to be able to detach it from the sowing machine. Usually, it is necessary to loosen screw connections between the supply container and the sowing machine in order to be able to detach the supply container. This also requires a great deal of time. With sowing machines with a brush strip (see U.S. Pat. No. 7,918,168 B1), which is used to move the seed from the meter to a furrow formed in the soil, an access to the brush strip is advantageous for maintenance purposes, where it is not enough to only tilt the seed container forward in a manner which is, in fact, known (John Deere 1100 Planter).

Sowing machines have been manufactured in which the supply container for the seed can be detached from the sowing machine together with the metering device (John Deere 1790 Front Fold Planter). In placing the supply container, a recess on the supply container is pushed over a screw of the sowing machine frame; then a nipple of the metering device is introduced into an opening of the frame; and finally, a hook of the frame is coupled with a clamp on the metering device. The removal takes place in an analogous manner, in a reverse sequence. Since the supply container is firmly connected with the metering device, this procedure appears to be advantageous for maintenance on the metering device, but not for the emptying of the supply container.

### SUMMARY

This problem is solved with the teaching of claim 1, while features that further develop the solution in an advantageous manner are indicated in the additional claims.

An agricultural machine, which can be, for example, a sowing machine or a centrifugal fertilizer spreader, is equipped with a frame, on which a discharging device for granular material and a supply container for granular material are fastened, which can be supplied to the discharging device. The supply container can be either removed or connected with the frame and the discharging device without the use of tools. The invention under consideration is, in particular, advantageous also if on the row unit, the seed is supplied to the furrow by means of a brush strip (see U.S. Pat. No. 7,918,168 B1). A removable supply container is likewise advantageous here, since this allows for enough space for access to the brush strip and to remove it if necessary.

In this way, the supply container can be quickly and simply removed, emptied, and/or cleaned.

The frame can comprise a holder that can be moved between a first position and a second position; it can be locked in the first position with a manually activated locking means and it comprises a holding area, which, in a first position from the top, lies on a support element of the supply container and, in the second position, is at a distance from the support element.

The holder can comprise a guide path, which, from below, is next to the support element, so that the support element is enclosed in the first position between the holding area and the guide path.

The locking means can comprise a spring-loaded catch, which embraces the support element.

There are two holding areas on each side of the supply container; they interact with each of the support elements of the supply container, and at least one is provided with a locking means.

The support element can lie in an indentation of the frame, if the supply container is fastened on the frame.

The supply container can have an opening on the bottom, through which the granular material can be supplied from the supply container to the discharging device and which can be shut by a closure on the supply container, which is activated in the supply container fastened on the machine.

The machine is, in particular, a (series) row unit of a sowing machine. The supply container, a furrow opener, a depth adjusting wheel, a seed tube or seed delivery system, and a metering device, used as a discharging device, are located on the frame, wherein the metering device is set up to successively remove seed from the supply container and supply it to the sowing a seed tube or seed delivery system which releases it into a furrow created by the furrow opener, whose depth is specified by the depth adjusting wheel.

On the frame, an intermediate container can be located between the supply container and the metering device; the intermediate container can be reconfigured for the use of the machine with its own supply container and a use of the machine with a common supply container used with other machines, from which the seed is pneumatically conveyed to the machine. This intermediate container could also be used in connection with a supply container that cannot be detached without the use of tools.

### BRIEF DESCRIPTION OF THE DRAWINGS

The drawings show an exemplary embodiment which is described below in more detail. The figures show the following:

FIG. 1, a perspective view of an agricultural machine in the form of a row unit with a granular material supply container that can be locked on it;

FIG. 2, a lateral view of the upper area of the machine from FIG. 1;

FIG. 3, a perspective view in accordance with FIG. 1, with the supply container, which has been brought into a second position and which can then be detached upward;

FIG. 4, the machine with a detached supply container;

FIG. 5, the machine with the detached supply container in a view from below; and

FIG. 6, a perspective view of the intermediate container of the machine.

### DETAILED DESCRIPTION

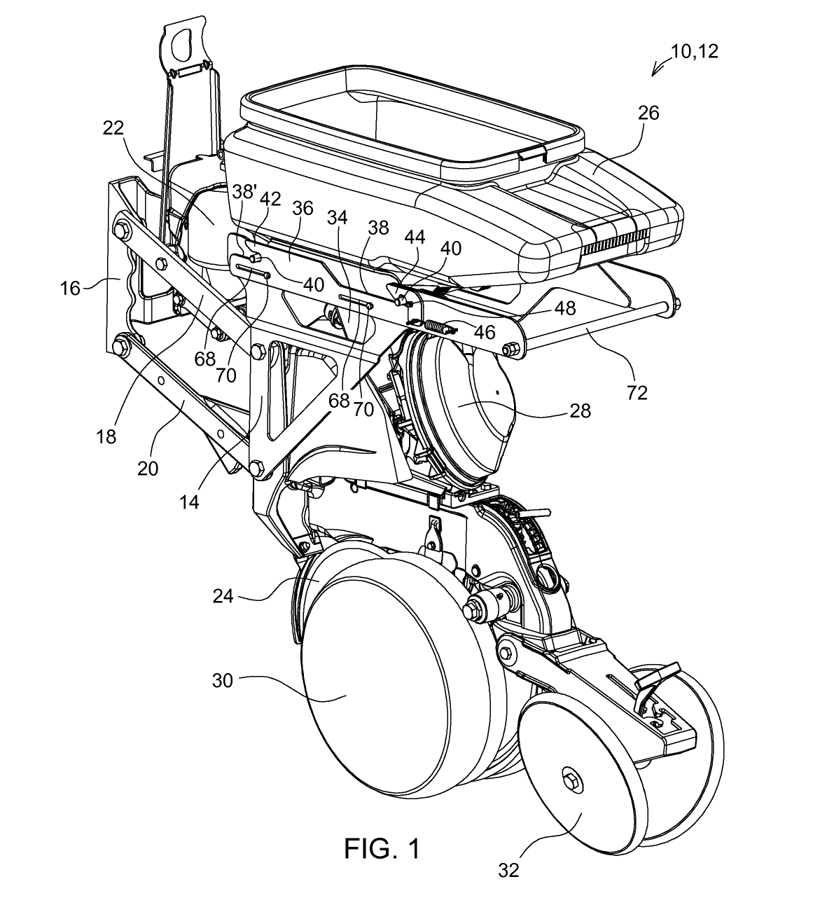

FIGS. 1 to 5 show an agricultural machine 10, which is designed as a row unit 12 for a sowing machine. The row unit 12 can be fastened on a crossbar (not shown), which is supported on wheels and is pulled by a tow bar behind a tractor or is held directly (without wheels) by a coupling arrangement of the tractor. The unit 12 has a frame 14. The fastening of the generally several row units 12 on the crossbar is carried out via U-shaped holders, which are connected with a console 16 and which are extended vertically on the back side of the crossbar and are hinged to two links 18, 20, one above the other, which are also hinged on the frame 14 of the row unit 12. With the console 16 and the frame 14, the links 18, 20 form an adjustable parallelogram, which defines the height of the frame above the ground. A pneumatic actor 22 defines the position of the frame 14 and the contact force with which a furrow opener 24, supported on the frame 14, interacts with the ground.

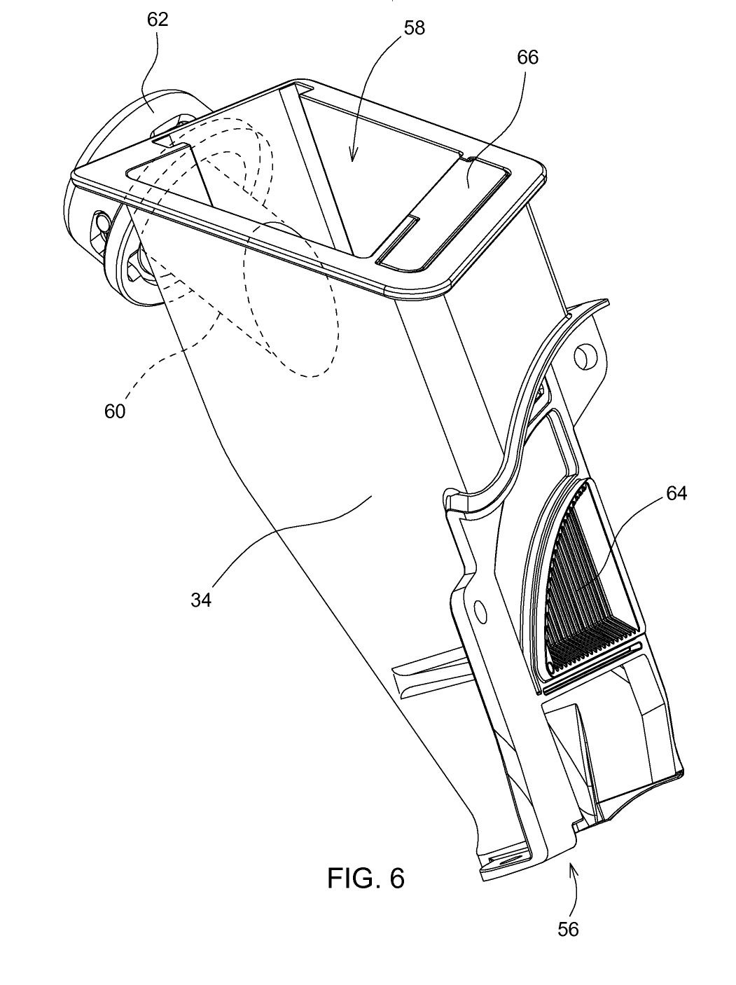

In a known manner, the frame 14 carries a supply container 26 for seed, a a seed tube or seed delivery system (which cannot be seen in the figure) and a (particularly pneumatic) metering device 28 (which works with a reduced pressure made available with a blower, which is not shown), which gradually releases individual seed grains from the supply container 26 into the a seed tube or seed delivery system, which deposits them into a furrow that has been created by the furrow opener 24, whose work depth is specified by a depth adjusting wheel 30. The furrow is closed by a pair of closing wheels 32. Reference is made to the disclosure of EP 2 517 545 A1 (U.S. Pat. No. 8,850,997B1) with regard to more details of the row units 12; the disclosure of which is incorporated by reference in the documents under consideration. An intermediate container 34 is located between the supply container 26 and the metering device 28; the intermediate container is shown in detail in FIG. 6. Preferably, a non-depicted sealing arrangement is located between the intermediate container 34 and the supply container.

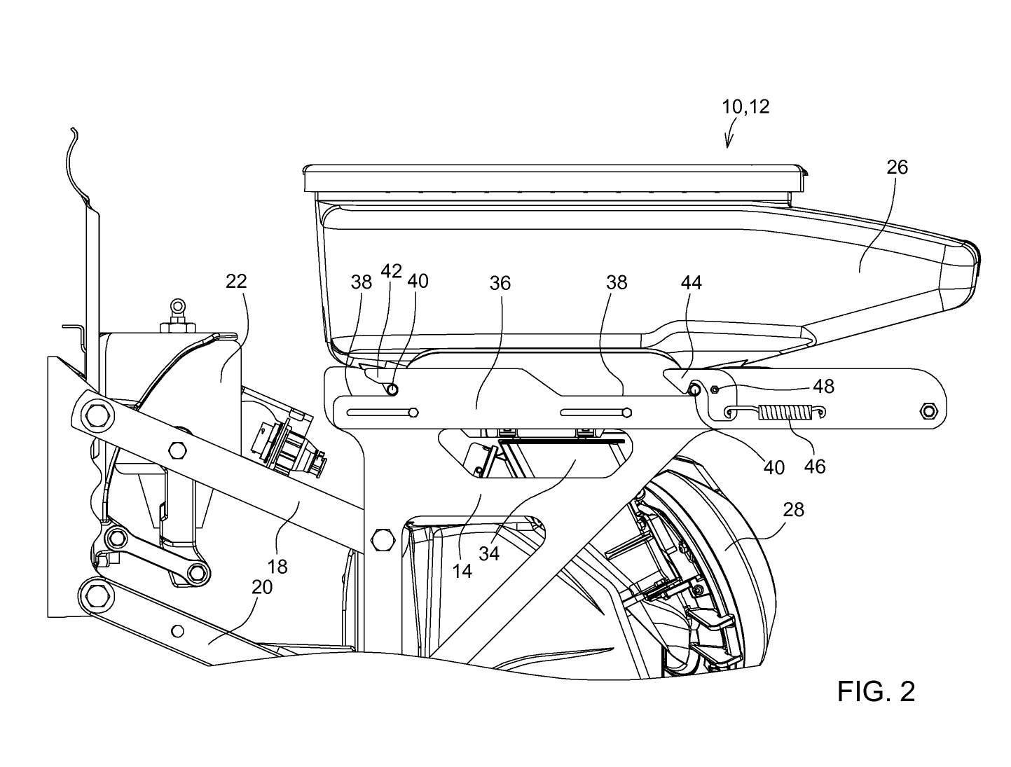

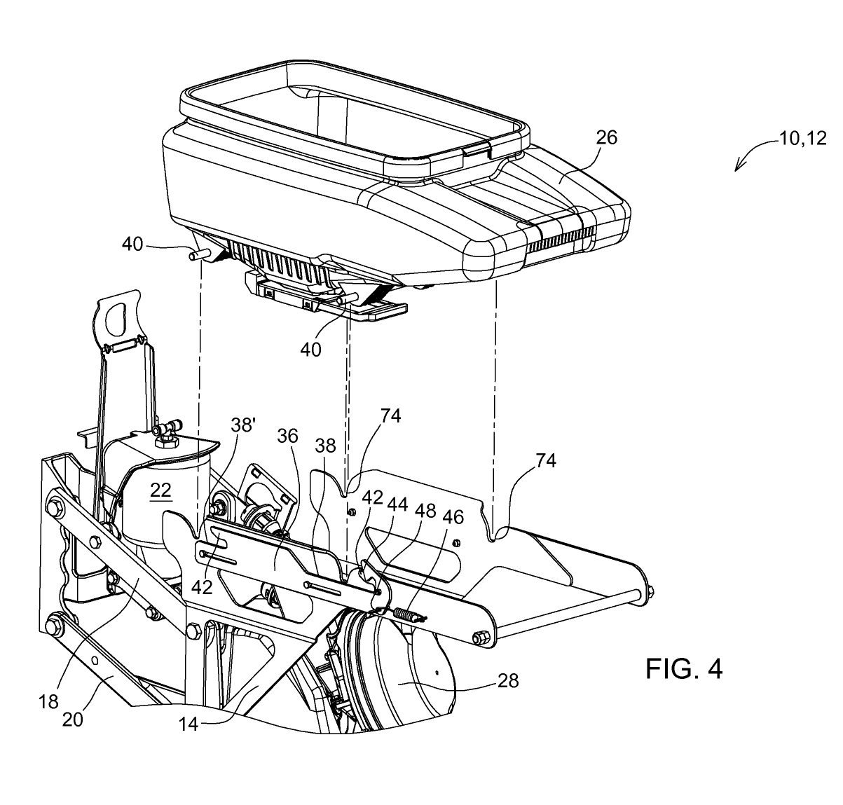

The supply container 26 is fastened on the frame 14 in such a manner that it can be detached. To this end, the frame 14 is coupled, on both sides, with a holder 36 that can be moved, in the direction of travel, opposite the frame 14; the holder has a rear guide path 38 and a front guide path 38′; they are oriented horizontally and are made as an upper flat edge, which is lowered downward, opposite the upper holder 36. The supply container 26 is provided on its underside with rod-shaped support elements 40, which extend laterally outward; the support elements penetrate the V-shaped indentations 74 of the frame 14 (see FIG. 4) and are supported on the bottom of the indentations 74 on the frame 14. The guide paths 38, 38′ lie, from below, on the rod-shaped support elements 40. From above, moreover, holding areas 42 of the holders 36 are next to the support elements 40. The holding areas 42 and the guide paths 38 and 38′ thus form a U, which is open toward the front and in which the support element 40 is found when locked. The holders 36 are connected with the frame 14, in the direction of travel (in FIG. 2, toward the right), by longitudinal holes 68, through which screws 70 penetrate, and are provided with a rear grip 72, which connects the two holders 36 with one another.

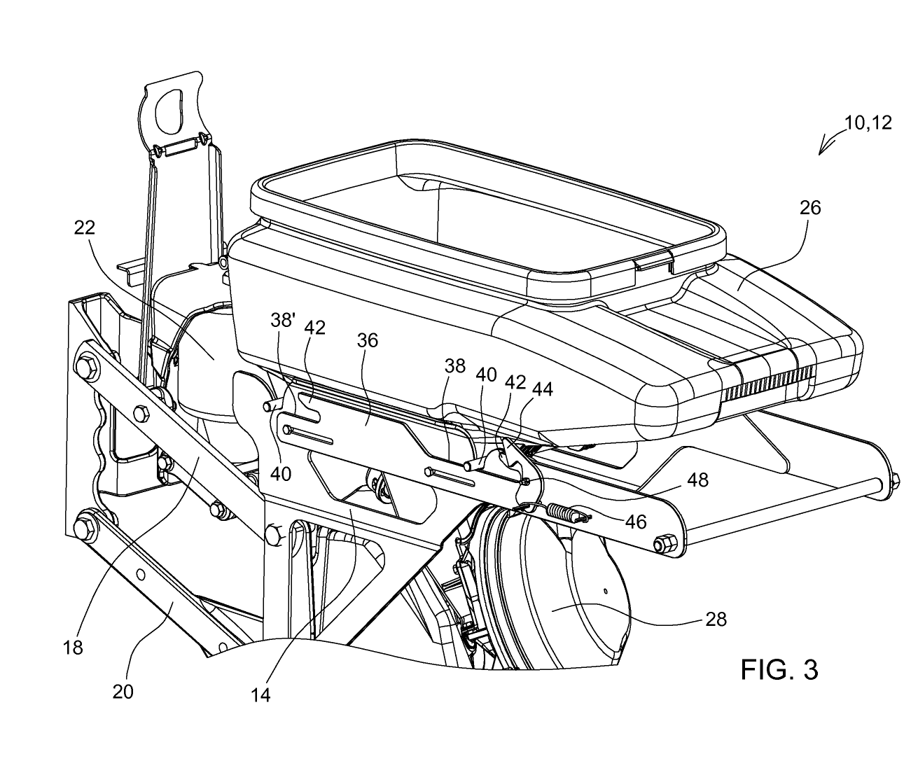

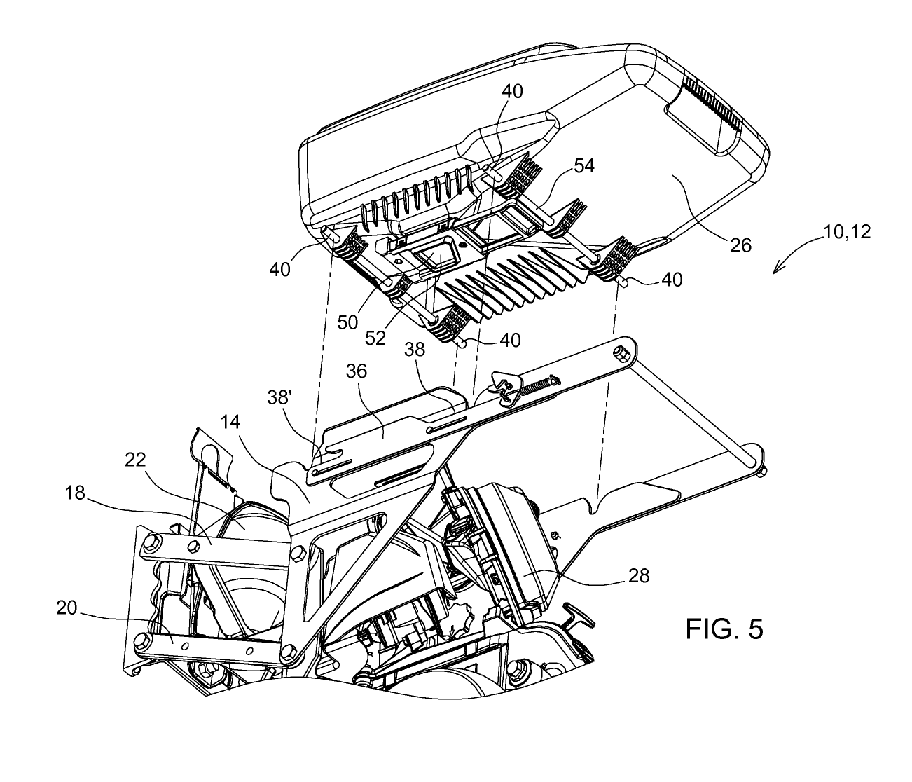

In the (first) position, shown in FIG. 1, the holder 36 is affixed on the frame 14 by a catch 44, which encompasses the rear support element 40 (lying in the indentation 74), from above. The catch 44, which can rotate around an axle 48, is hinged on the holder 36 and prestressed by a spring 46, placed with one end on the holder 36 and the other end on the catch 44, and held in the position shown. By rotating the catch 44 (in FIG. 1, in the clockwise direction), the operator can loosen the lock of the holder 36 and then pull the holder 36 on the grip 72 backward, see FIG. 3, and finally, since the support elements 40 are then no longer covered upward by the holding areas 44 and thus held on the frame 14, as shown in FIGS. 4 and 5, detach it upward. Beforehand, a bottom opening 50 of the supply container 26 can be closed by means of a guillotine-like closure 52, which can be activated by means of a grip 54 from the rear of the row unit 12 (in FIG. 1, from the right). The supply container 26 can then be emptied (tilted out) and/or cleaned.

FIG. 6 shows an enlarged view of the intermediate container 34. It is an elongated body with a lower opening 56, which transfers the granular material (seed) from the supply container 26 to the metering device 28, and an upper opening 58, which with the supply container 26 fastened on the row unit 12, is aligned with the bottom opening of the supply container 28. A connecting piece 60, directed forwards, which is closed by a cover 62, is set in the upper area of the intermediate container 34. A lower, rear venting grid 64 is closed by a guillotine-like closure 66. The intermediate container 34 thus makes it possible to use the row unit 12 with a supply container 26 correlated with it, if the depicted configuration is used with the closed venting grid 64 and the closed connecting piece 60, and the upper opening 58 is opened. The row unit 12 can, however, also be reconfigured so as to be used with a larger supply container (not depicted), jointly used by several row units 12. Then, the upper opening 58 is closed by a suitable lid (not shown); the closure 66 is drawn out upwards, so as to open the venting grid 64 and a conduit is coupled on the connecting piece 60; the conduit transports the seed pneumatically from the larger supply container to the intermediate container 34. The air required for this can then escape through the venting grid 64.

1. Agricultural machine comprising:
a frame, on which are fastened a discharging device for granular material and a supply container for granular material, which can be supplied to the discharging device, wherein the supply container can be removed and thus reconnected with the frame and the discharging device without the use of any tools wherein the storage container is provided on its underside at both sides with outwardly extending support members which penetrate respectively into V-shaped recesses of the frame and are supported on the bottom of the recesses on the frame when the reservoir is attached to the frame;
a holder on each side the frame which is displaceable between a first position and a second position wherein the holder includes a holding portion which rests in the first position, from the top, on one of the support members and in the second position the holder is spaced from the supporting member; and a handle connected to the holders wherein at least one of the holders can be locked by manually operable locking means in the first position.

2. Machine according to claim 2, wherein the holder comprises a guide path, which, from below, is next to the support element, so that the support element is enclosed, in the first position, between the holding portion and the guide path.

3. Machine according to claim 2, wherein the locking means comprise a spring-loaded catch, which encompasses the support element.

4. Machine according to claim 1, wherein, on each side of the supply container, there are two holding portions, which interact with a support element of the supply container and of which at least one is provided with a locking means.

5. Machine according to claim 1, wherein the supply container has an opening, by means of which the granular material can be supplied from the supply container to the discharging device and which can be closed by a closure placed on the supply container.

6. Machine according to claim 1, wherein the machine is a row unit and the supply container, a furrow opener, a depth adjusting wheel, and a metering device used as a discharging device are placed on the frame, wherein the metering device is operable to successively remove seed from the supply container and release it into a furrow created by the furrow opener, whose depth is specified by the depth adjusting wheel.

7. Machine according to claim 6, further comprising, an intermediate container located between the supply container and the metering device, which can be reconfigured for the use of the machine with its own supply container and a use of the machine with a common supply container used with other machines.
